(19) United States
(12) Patent Application Publication
(10) Pub. No.: US 2007/0090925 A1
(43) Pub. Date: Apr. 26, 2007

(54) Radio communication system

(75) Inventors: Makoto Tanaka, Obu-city (JP); Kazuoki Matsugatani, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/455,869

(22) Filed: Jun. 20, 2006

(30) Foreign Application Priority Data
Oct. 20, 2005 (JP) 2005-305962

(51) Int. Cl. H04Q 5/22

(52) U.S. Cl. 340/10.1; 340/572.1; 343/756

(57) ABSTRACT

A radio communication system includes: a communication control device; a radio tag for communicating with the communication control device; an antenna for transmitting an incident wave; and a first reflective plate for reflecting the incident wave as a first reflected wave. The radio tag is disposed between the antenna and the first reflective plate. The radio tag communicates with the communication control device in a region, in which the incident wave and the first reflected wave are overlapped. The first reflective plate reflects the incident wave in such a manner that the first reflected wave has a polarization different from a polarization of the incident wave.

### CROSS REFERENCE TO RELATED APPLICATION

This application is based on Japanese Patent Application No. 2005-305962 filed on Oct. 20, 2005, the disclosure of which is incorporated herein by reference.

### FIELD OF THE INVENTION

The present invention relates to a radio communication system.

### BACKGROUND OF THE INVENTION

A radio communication system performs delivery and receipt of information through radio communication in an RF (Radio Frequency) band with respect to a radio tag as an information medium.

The above type of a radio communication system has been known, as shown in FIG. 18.

That is, in the radio communication system, a radio tag 1 as an information medium, into which, for example, identification information (ID) of a person or an article is registered, is used as an object. A communication control device 2 is provided, which performs delivery and receipt of information with respect to a memory and a control circuit of the memory incorporated in the radio tag 1 through radio communication using an electromagnetic wave in the RF band as a carrier wave. The communication control device 2 has information processing capability through communication such as capability of read or write of the identification information (ID) with respect to the radio tag 1.

Here, when the communication control device 2 performs delivery and receipt of information with respect to the radio tag 1, for example, requests acquisition of the identification information (ID), the device transmits request information indicating that matter via an antenna 3 as a modulated signal. Thus, the radio tag 1 receives the modulated signal via the antenna (omitted to be shown) and demodulates the signal to recognize content of the signal as acquisition request of the identification information (ID). Then, the radio tag accesses a memory incorporated in itself through the control circuit to read the identification information (ID) stored in the memory and transmit it to the communication control device 2 as a modulated signal as well. Through such processing between the communication control device 2 and the radio tag 1, the identification information (ID) of the person or article registered in the radio tag 1 is acquired by the communication control device 2 and used for verification and the like.

In such a radio communication system, in order to improve reliability in radio communication with respect to the radio tag 1, the following is important: improvement in intensity of an electromagnetic wave imparted to the radio tag; expansion of an area of receiving the electromagnetic wave by the radio tag; and relaxation of electromagnetic-wave interference.

Thus, in the related art, for example, as in a radio communication system disclosed in Japanese Patent Application Publication No. 2005-5876, a system has been proposed, in which a carrier wave radiated from the antenna 3 of the communication control device 2 is intentionally reflected.

That is, in the radio communication system, as shown in FIG. 19, a reflective plate 4 is arranged oppositely to the antenna 3 in a manner of sandwiching a region where the radio tag 1 is present, and a reflective surface of the reflective plate 4 is made convex in order to expand an area of reading the radio tag 1 by the communication control device 2 via the antenna 3. According to such a configuration, as shown in FIG. 19, since an electromagnetic wave transmitted from the antenna 3 is received by the radio tag 1 situated in a region Q1 between the antenna 3 and the reflective plate 4, in addition, by a radio tag 1 situated in a region Q2 expanded by the reflective plate 4, communication environment between the communication control device 2 and the radio tag 1 is significantly improved. Here, IW represents an incident electromagnetic wave, and RW represents a reflected electromagnetic wave.

In this way, according to the radio communication system, the communication environment between the communication control device 2 and the radio tag 1 is surely improved by arranging the reflective plate 4. However, particularly in the region Q1 where an electromagnetic wave IW transmitted from the antenna 3 and an electromagnetic wave RW reflected by the reflective plate 4 are mixed, a so-called standing wave is generated due to interference between the electromagnetic waves IW and RW. FIG. 20 schematically shows a generation mode of such a standing wave CW.

As shown in FIG. 20, the standing wave CW is an electromagnetic wave having a cycle of a half-wavelength of the carrier wave (RF), wherein an amplitude value is typically small compared with the electromagnetic wave IW transmitted from the antenna 3 at a phase (null point) where the amplitude value is minimized. That is, in the radio communication system, while improvement in field strength is achieved in a radio tag 1a placed at a phase where the amplitude value is maximized, the field strength is conversely reduced in a radio tag 1b placed at the null point, and the electromagnetic wave (modulated signal) transmitted from the communication control device 2 can be hardly received. In particular, when the radio tag 1b is configured by a radio tag in a passive type without incorporating a power source, there is even a worry that a drive source can not be secured depending on intensity of the electromagnetic wave transmitted from the communication control device 2.

Such a standing wave CW is typically generated only by interference of the electromagnetic wave transmitted from the antenna 3 with a reflected wave reflected not only by the reflective plate 4, but also by a reflective body (an appropriate metal member) present in a forward direction of the electromagnetic wave. Even in this case, for a radio tag placed at the null point of the standing wave generated in such a way, an adverse effect on communication environment of the tag is still inevitable.

### SUMMARY OF THE INVENTION

In view of the above-described problem, it is an object of the present disclosure to provide a radio communication system.

According to an aspect of the present disclosure, a radio communication system includes: a communication control device for processing information through a radio communication; a radio tag as an information media for communicating with the communication control device through the radio communication; an antenna for transmitting an electromagnetic wave as an incident wave from the communication control device to the radio tag; and a first reflective plate for reflecting the electromagnetic wave transmitted from the antenna as a first reflected wave, wherein the radio tag is disposed between the antenna and the first reflective plate. The radio tag communicates with the communication control device in a region, in which the incident wave and the first reflected wave are overlapped. The first reflective plate reflects the incident wave in such a manner that the first reflected wave has a polarization different from a polarization of the incident wave.

In the above device, interference between the incident wave and the reflection wave is reduced, i.e., relaxed, so that generation of a standing wave is limited. Further, the radio tag and the control device are capable of communicating each other sufficiently in the region, in which the incident wave and the reflected wave are overlapped. Thus, the intensity of electromagnetic wave to be inputted into the radio tag is increased. Here, the above system is suitably used for a system using a UHF band such as 950 MHz.

Alternatively, the incident wave may be a linearly-polarized wave, and the first reflected wave may be a linearly-polarized wave. Here, the radio tag generally has an antenna for receiving the linearly-polarized wave so that the radio tag communicates with the communication control device. The antenna for the linearly-polarized wave has high directivity. Therefore, it may be difficult for the radio tag to receive the linearly-polarized wave from the communication control device in a certain case having a certain relationship between the polarization of the linearly-polarized wave and the position of the radio tag. However, in the above device, the reflected wave has the polarization different from that of the incident wave, so that the radio tag receives two different types of the electromagnetic wave from the communication device. Thus, even if the relationship between the polarization of the linearly-polarized wave and the position of the radio tag is a certain relationship, the radio tag can receive the linearly-polarized wave from the communication control device sufficiently. Further, the polarization of the first reflected wave may be perpendicular to the polarization of the incident wave.

Alternatively, the system may further include: a second reflective plate disposed on an opposite side of the first reflective plate so that the antenna and the tag are disposed between the first reflective plate and the second reflective plate. The second reflective plate reflects the first reflected wave as a second reflected wave, and the second reflected wave has a polarization, which is different from the polarization of the first reflected wave. In this case, not only the interference between the incident wave and the first reflected wave, but also the interference between the first reflected wave and the second reflected wave are reduced, i.e., relaxed. Thus, the standing wave between the antenna and the first and second reflective plates are sufficiently restricted. Further, the radio tag can receive the incident wave, the first and second reflected waves so that the intensity of the electromagnetic wave received by the radio tag is much increased.

### BRIEF DESCRIPTION OF THE DRAWINGS

The above and other objects, features and advantages of the present invention will become more apparent from the following detailed description made with reference to the accompanying drawings. In the drawings:

FIGS. 1A to 1D are schematic views showing a relationship between an electric field and a propagation direction of an electromagnetic wave in order to explain a principle of the present invention;

FIGS. 2A to 2H are schematic views showing a relationship between an electric field and a propagation direction of an electromagnetic wave in order to explain the principle of the present invention;

FIGS. 3A, 3C, 3E and 3G are schematic views showing a reflective plate and an electromagnetic wave, and FIGS. 3B, 3D, 3F and 3H are schematic views showing a relationship between a vector component and an electric field of an electromagnetic wave, in order to explain the principle of the present invention;

FIG. 4A is a distribution view showing an electromagnetic field intensity in a region, in which an incident wave and a reflected wave shown in FIGS. 1A and 1B or 1C and 1D are overlapped, FIG. 4B is a distribution view showing an electromagnetic field intensity in a region, in which an incident wave and a reflected wave shown in FIGS. 2A to 2H are overlapped, and FIG. 4C is a distribution view showing an electromagnetic field intensity in a region, in which an incident wave and a reflected wave are not overlapped;

FIG. 5 is a schematic view showing a radio communication system according to a first embodiment of the present invention;

FIGS. 6A and 6B are plan views showing a relationship among a reflective plate, an incident wave and a reflected wave, according to the first embodiment;

FIGS. 7A to 7N are plan views showing a relationship among a reflective plate, an incident wave and a reflected wave, according to a first to seventh modifications of the first embodiment;

FIG. 8A is a plan view showing a reflective plate in a radio communication system according to a second embodiment of the present invention, FIG. 8B is a cross sectional view showing the reflective plate taken along line VIIIB-VIIIB in FIG. 8A, and FIG. 8C is a partially enlarged cross sectional view showing a part of the reflective plate VIIIC in FIG. 8B;

FIGS. 9A and 9B are plan views showing a relationship among a reflective plate, an incident wave and a reflected wave, according to the second embodiment;

FIG. 10 is a graph showing reflective characteristics of the reflective plate, according to the second embodiment;

FIGS. 11A to 11F are plan views showing a relationship among a reflective plate, an incident wave and a reflected wave, according to a first to third modifications of the second embodiment;

FIGS. 12A to 12H are plan views showing a relationship among a reflective plate, an incident wave and a reflected wave, according to a fourth to seventh modifications of the second embodiment;

FIGS. 13A to 13H are plan views showing a relationship among a reflective plate, an incident wave and a reflected wave, according to an eighth to eleventh modifications of the second embodiment;

FIG. 14 is a schematic view showing a radio communication system according to a third embodiment of the present invention;

FIG. 15 is a schematic view showing a radio communication system according to a fourth embodiment of the present invention;

FIG. 16 is a schematic view showing a radio communication system according to a fifth embodiment of the present invention;

FIG. 17 is a schematic view showing a radio communication system according to a sixth embodiment of the present invention;

FIG. 18 is a schematic view showing a radio communication system according to a prior art;

FIG. 19 is a schematic view showing reflective characteristics of a reflective plate in the system according to the prior art; and

FIG. 20 is a schematic view showing a relationship between a null point of a standing wave and a radio tag, according to the prior art.

### DETAILED DESCRIPTION OF THE PREFERRED EMBODIMENTS

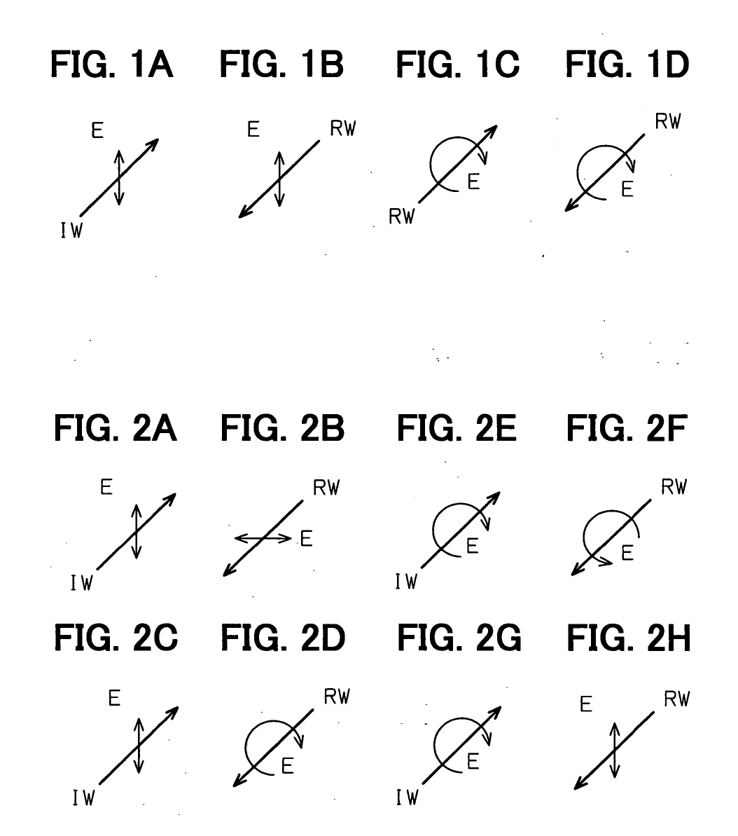

First, a principle of embodiments of the invention is described with reference to FIGS. 1A to 4C.

As described before, in a radio communication system, in order to improve reliability in radio communication between a communication control device having information processing capability through communication and a radio tag as an information medium, the following is effective; improvement in intensity of the electromagnetic wave imparted to the radio tag; expansion of an area of receiving the electromagnetic wave by the radio tag; and relaxation of electromagnetic-wave interference. Therefore, an electromagnetic wave in an RF band radiated from an antenna of the communication control device is reflected by a reflective plate, and delivery and receipt of information with respect to the radio tag may be performed through the electromagnetic wave transmitted from the antenna and a reflected wave of the electromagnetic wave. However, in such a radio communication system, in a region where the electromagnetic wave transmitted from the antenna and the electromagnetic wave reflected by the reflective plate are mixed, the so-called standing wave is generated due to interference between the electromagnetic waves, and an adverse effect on communication environment of the radio tag is inevitable for a radio tag placed at a null point of the standing wave generated in this way, as described before.

For example, when it is assumed that an electromagnetic wave in the RF band was radiated from the antenna as a linearly-polarized wave, and the electromagnetic wave has been injected into a reflective plate (omitted to be shown) formed of an appropriate metal plate, the reflective plate typically reflects an electromagnetic wave (reflected wave) RW having the same polarization plane as that of the injected electromagnetic wave (injected wave, i.e., incident wave) IW, as shown in FIGS. 1A and 1B. Here, E represents an electric field of each wave IW, RW. Thus, in a region where such electromagnetic waves IW and RW are mixed, the electromagnetic waves IW and RW interfere with each other in the respective polarization planes, leading to generation of the standing wave.

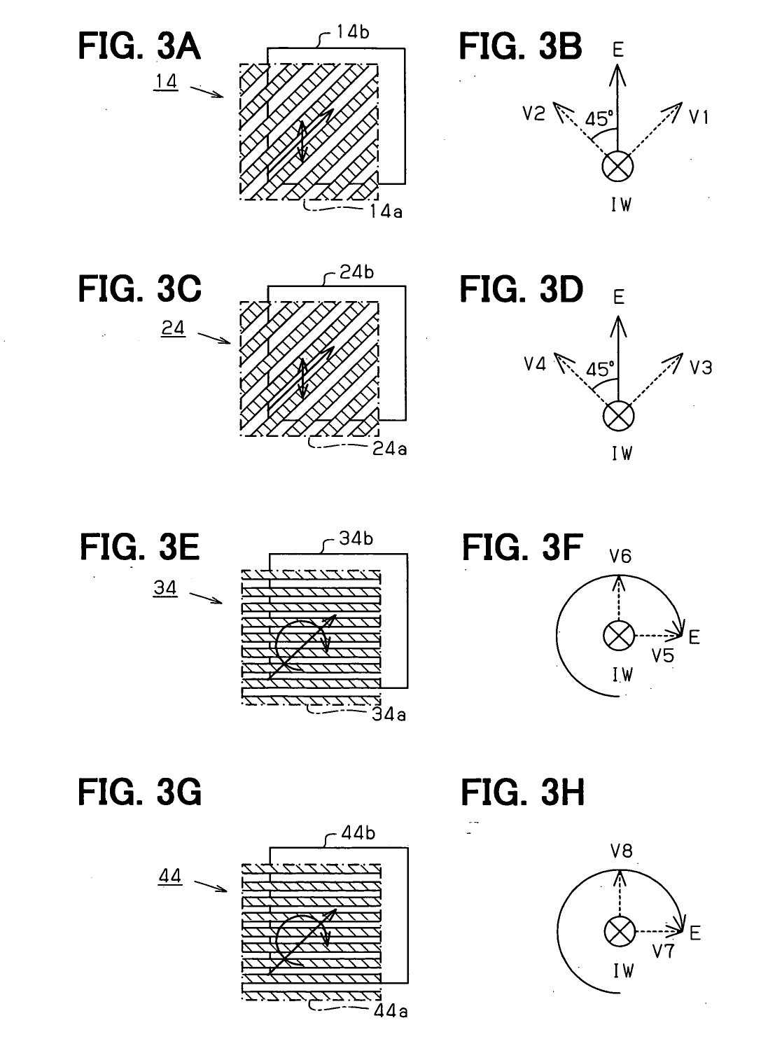

However, even in such a case, as shown in FIGS. 2A and 2B, when an electromagnetic wave (reflected wave) RW, of which the polarization plane (a plane in which an electric field varies) is perpendicular to that of the injected wave IW of the linearly-polarized wave, is designed to be reflected, interference between the electromagnetic waves IW and RW is preferably relaxed. That is, even in the case that delivery and receipt of information with respect to the radio tag is performed through the electromagnetic wave IW transmitted from the antenna and the reflected wave RW of the electromagnetic wave, preferable communication environment can be kept at any time. Regarding the reflective plate having such a reflective function, for example, a reflective plate 14 is used practically desirably, in which, as shown in FIGS. 3A and 3B, a reflective structure has: metal slits 14a that transmit a vector component V2 in the injected wave IW, the component being inclined by 45 degrees with respect to a polarization plane E of the injected wave, and reflects a component V1 perpendicular to the vector component V2; and a metal plate 14b that is arranged separately from the metal slits 14a in a manner of sandwiching an appropriate dielectric to the metal slits 14a, and reflects the vector component V2 transmitted through the metal slits 14a in the injected wave IW, and difference in phase (reflection phase) before and after reflection of the vector component V2 is “zero degrees”. In such a reflective plate 14, the polarization plane of the reflected wave RW (FIGS. 2A and 2B) becomes perpendicular to the polarization plane of the injected wave IW through adjustment of a synthesized mode of the vector components V1 and V2 reflected by the metal slits 14a and the metal plate 14b respectively. As a material of the metal slits 14a and the metal plate 14b, an appropriate metal such as aluminum can be used. As a material of the dielectric provided between the metal slits 14a and the metal plate 14b, an appropriate dielectric such as Styrofoam can be used.

For the injected wave IW injected as the linearly-polarized wave, even if an electromagnetic wave (reflected wave) RW of a circularly-polarized wave is designed to be reflected as shown in FIGS. 2C and 2D, interference between the electromagnetic waves IW and RW can be preferably relaxed. Regarding a reflective plate having such a reflective function, for example, a reflective plate 24 is used practically desirably, in which, as shown in FIGS. 3C and 3D, a reflective structure has: metal slits 24a that transmits a vector component V4 in the injected wave IW, the component being inclined by 45 degrees with respect to a polarization plane of the injected wave, and reflects a component V3 perpendicular to the vector component V4; and a metal plate 24b that is arranged separately from the metal slits 24a in a manner of sandwiching an appropriate dielectric to the metal slits 24a, and reflects the vector component V4 transmitted through the metal slits 24a in the injected wave IW, and difference in phase (reflection phase) before and after reflection of the vector component V4 is “+90 degrees” or “−90 degrees”. According to such a reflective plate 24, the circularly-polarized wave is reflected as the reflected wave RW (FIGS. 2C and 2D) with respect to the injected wave IW of the linearly-polarized wave through adjustment of a synthesized mode of the vector components V3 and V4 reflected by the metal slits 24a and the metal plate 24b respectively.

On the other hand, when the electromagnetic wave in the RF band is radiated from the antenna as the circularly-polarized wave, and the electromagnetic wave is injected into the reflective plate (omitted to be shown) formed of the appropriate metal plate, similarly, the reflective plate typically reflects the reflected wave RW of the circularly-polarized wave of which the rotation direction is reverse to that of the injected electromagnetic wave (injected wave) IW in each of forward directions, as shown in FIGS. 1C and 1D. In this case, the electromagnetic waves IW and RW interfere with each other, leading to generation of the standing wave.

However, even in such a case, when, as shown in FIGS. 2E and 2F, for the injected wave IW injected as the circularly-polarized wave, a circularly-polarized wave of which the rotation direction is the same as that of the injected wave in each of the forward directions is designed to be reflected as the reflected wave RW, interference between the electromagnetic waves IW and RW is preferably relaxed. That is, even in the case that delivery and receipt of information with respect to the radio tag is performed through the electromagnetic wave IW transmitted from the antenna and the reflected wave RW of the electromagnetic wave, preferable communication environment can be kept at any time. Regarding the reflective plate having such a reflective function, for example, a reflective plate 34 is used practically desirably, in which, as shown in FIGS. 3E and 3F, a reflective structure has: metal slits 34a that transmits a particular vector component V6 in the injected wave IW, and reflects a component V5 perpendicular to the vector component V6; and a metal plate 34b that is arranged separately from the metal slits 34a in a manner of sandwiching an appropriate dielectric to the metal slits 34a, and reflects the vector component V6 transmitted through the metal slits 34a in the injected wave IW, and difference in phase (reflection phase) before and after reflection of the vector component V6 is “zero degrees”. According to such a reflective plate 34, the circularly-polarized wave of which the rotation direction is the same as that of the injected wave IW in each of the forward directions is reflected as the reflected wave RW (FIGS. 2E and 2F) of the injected wave IW, through adjustment of a synthesized mode of the vector components V5 and V6 reflected by the metal slit 34a and the metal plate 34b respectively.

For the injected wave IW injected as the circularly-polarized wave, even if a reflected wave RW of a linearly-polarized wave is designed to be reflected as shown in FIGS. 2G and 2H, interference between the electromagnetic waves IW and RW can be preferably relaxed, and preferable communication environment can be kept at any time. Regarding a reflective plate having such a reflective function, for example, a reflective plate 44 is used practically desirably, in which, as shown in FIGS. 3G and 3H, a reflective structure has: metal slits 44a that transmits a particular vector component V8 in the injected wave IW, and reflects a component V7 perpendicular to the vector component V8; and a metal plate 44b that is arranged separately from the metal slits 44a in a manner of sandwiching an appropriate dielectric to the metal slits 44a, and reflects the vector component V8 transmitted through the metal slits 44a in the injected wave IW, and difference in phase (reflection phase) before and after reflection of the vector component V8 is “+90 degrees” or “−90 degrees”. According to such a reflective plate 44, the linearly-polarized wave is reflected as the reflected wave RW (FIGS. 2G and 2H) of the injected wave IW of the circularly-polarized wave through adjustment of a synthesized mode of the vector components V7 and V8 reflected by the metal slits 44a and the metal plate 44b respectively.

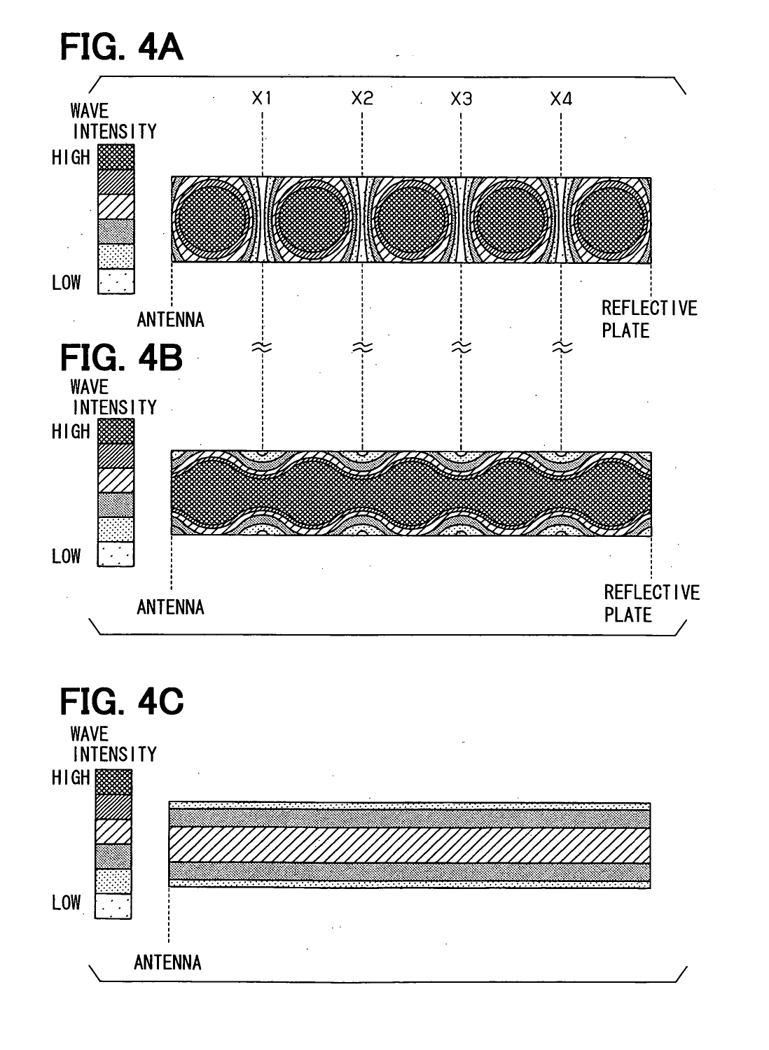

FIG. 4A is a distribution view showing intensity of an electromagnetic wave in a region where, when the electromagnetic wave radiated from the antenna of the communication control device is reflected in the mode previously exemplified in FIGS. 1A and 1B or 1C and 1D, the injected wave and the reflected wave are overlapped. On the other hand, FIG. 4B is a distribution view showing intensity of an electromagnetic wave in a region where, when the electromagnetic wave radiated from the antenna of the communication control device is reflected in one of the modes previously exemplified in FIGS. 2A to 2H, the injected wave and the reflected wave are overlapped. FIG. 4C shows distribution of intensity of an electromagnetic wave when the electromagnetic wave radiated from the antenna of the communication control device is not reflected for reference.

As obviously shown from the FIGS. 4A and 4B, according to the reflection modes previously exemplified in FIGS. 2A to 2H, reduction in intensity of the electromagnetic wave at the null points X1 to X4 is preferably suppressed, and consequently preferable communication environment can be kept at any time. Moreover, while generation of the standing wave is suppressed in this way, the delivery and receipt of information is performed with respect to the radio tag in a region where the electromagnetic wave transmitted from the antenna of the communication control device and the reflected wave of the electromagnetic wave are overlapped, therefore improvement in intensity of the electromagnetic wave imparted to the radio tag can be expected as known from FIGS. 4B and 4C.

(First Embodiment)

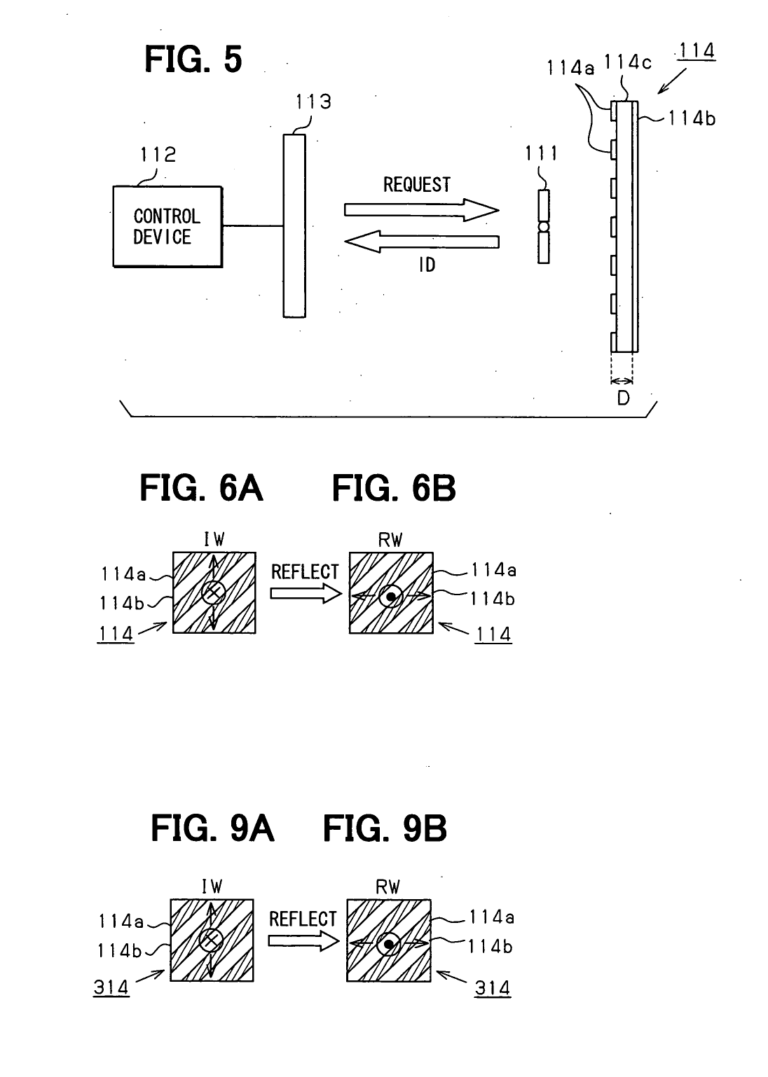

FIGS. 5 to 6B show a first embodiment of a radio communication system according to the invention configured based on such a principle. FIG. 5 shows a general configuration of a radio communication system according to the embodiment. FIGS. 6A and 6B schematically show a reflection structure of a reflective plate of the embodiment, and a relationship between an electromagnetic wave (injected wave) injected into the reflective plate and a reflected wave of the injected wave. In FIGS. 6A and 6B, a relationship between metal slits and a metal plate in the reflective plate is particularly shown, and a dielectric between the metal slits and the metal plate is omitted to be shown for convenience.

As shown in FIG. 5, the radio communication system according to the embodiment is roughly configured to have; a communication control device 112 having, an information processing function through communication, a read or write function of identification information with respect to a radio tag 111 and the like, with the radio tag 111 as an information medium into which identification information (ID) of a person or an article is registered as an object; an antenna 113 that radiates an electromagnetic wave including a linearly-polarized wave in a UHF band (for example, 950 MHz) as a modulated signal in delivery and receipt of information between the radio tag 111 and the communication control device 112, for example, in transmission request of the identification information by the communication control device 112; a reflective plate 114 that is arranged oppositely to the antenna 113, and reflects the electromagnetic wave (modulated signal) radiated from the antenna 113 beyond the radio tag 111, and the like.

Among them, in the reflective plate 114, as collectively shown in FIGS. 6A and 6B, a reflective structure has; (A) metal slits 114a that transmit a vector component in an injected wave IW, which is inclined by 45 degrees to a polarization plane of the injected wave, and reflects a component perpendicular to the vector component; and (B) a metal plate 114b that is arranged separately from the metal slits 114a in a manner of sandwiching an appropriate dielectric substrate 114c to the metal slits 114a, and reflects the vector component transmitted through the metal slits 114a in the injected wave IW. Here, difference in phase (reflection phase) before and after reflection of the vector component transmitted through the metal slits 114a is made to be “zero degrees”, thereby interference between the injected wave IW and a reflected electromagnetic wave (reflected wave) RW of the injected wave is relaxed. Relaxation modes of the electromagnetic waves IW and RW and a reflection structure of the reflective plate 114 are essentially the same as those previously described exemplifying FIGS. 2A and 2B, and FIGS. 3A and 3B.

However, as shown in FIG. 5, in the reflective plate 114, when a wavelength of the injected electromagnetic wave (injected wave). IW in the dielectric 114c is assumed to be “λg”, a distance D between the metal slits 114a and the metal plate 114b is set to be “λg/4” in electric length. That is, in the reflective plate 114, a reflection phase of a vector component transmitted through the metal slits 114a is made to be “zero degrees” through setting of the distance D between the metal slits 114a and the metal plate 114b.

As described hereinbefore, according to the radio communication system according to the embodiment, excellent advantages as described below are obtained.

(1) When the electromagnetic wave IW transmitted from the communication control device 112 to the radio tag 111 via the antenna 113 is the linearly-polarized wave, the reflective plate 114 has a reflection structure where the reflective plate reflects the electromagnetic wave (reflected wave) RW of the linearly-polarized wave of which the polarization plane is perpendicular to the injected wave IW injected as the linearly-polarized wave. Therefore, interference between the injected wave IW and the reflected wave RW is relaxed, and consequently generation of the standing wave can be preferably suppressed. In addition, while generation of such a standing wave is suppressed, the delivery and receipt of information is performed with respect to the radio tag 111 in a region where the electromagnetic wave IW transmitted from the antenna 113 and the reflected wave RW of the electromagnetic wave are overlapped, therefore improvement in intensity of the electromagnetic wave imparted to the radio tag 111 can be expected.

(2) Since the reflective plate 114 is used, in which the polarization plane of the reflected wave RW is perpendicular to the polarization plane of the injected wave IW injected as the linearly-polarized wave, the radio tag 111 is radiated with two types of electromagnetic waves IW and RW having different polarization planes. Therefore, even if the radio tag 111 has an antenna for receiving a linearly-polarized wave, the radio tag 111 can appropriately receive information from the communication control device 112 irrespective of a type of the polarization plane of the electromagnetic wave IW transmitted from the communication control device 112 via the antenna 113.

The radio communication system can be practiced not only by using the reflective plate or the reflection structure of the plate, but also by reflective plates or reflection structures such as appropriate modifications of those as exemplified below.

(First Modification)

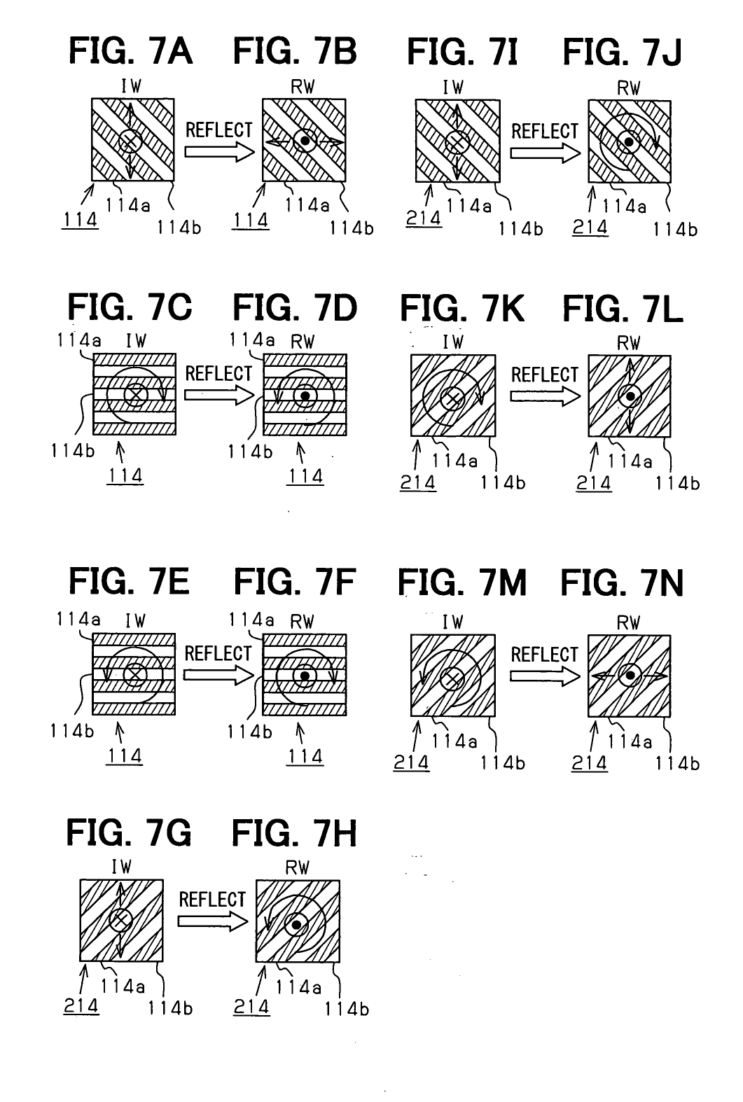

In the embodiment, as shown in FIGS. 6A and 6B, the reflective plate 114 was arranged in a manner that the metal slits 114a of the plate were inclined by 45 degrees clockwise with respect to the polarization plane of the injected wave IW. However, when the electromagnetic wave IW transmitted from the communication control device 112 via the antenna 113 is linearly-polarized wave, the reflective plate 114 can be arranged in a mode as shown in FIGS. 7A and 7B with respect to the electromagnetic wave IW.

That is, the reflective plate 114 is arranged in a manner that the metal slits 114a of the plate are inclined by 45 degrees counterclockwise with respect to the polarization plane of the injected wave IW herein. Even in such a reflection structure, the polarization plane of the electromagnetic wave RW reflected by the reflection plate 114 is perpendicular to the polarization plane of the injected wave IW injected from the antenna 113 as the linearly-polarized wave.

Therefore, according to such a modification, approximately the same advantages as those described in (1) and (2) are obtained.

(Second Modification)

As shown in FIGS. 7C and 7D, even if an electromagnetic wave IW transmitted from the communication control device 112 via the antenna 113 is a circularly-polarized wave that rotates clockwise with respect to a forward direction, the reflective plate 114 can be used. In such a configuration, according to a principle previously described exemplifying FIGS. 2E and 2F, and FIGS. 3E and 3F, a circularly-polarized wave that rotates clockwise with respect to the forward direction as well is reflected as the reflected wave RW.

Therefore, according to such a modification, approximately the same advantage as that described in (1) is obtained.

(Third Modification)

As shown in FIGS. 7E and 7F, when the electromagnetic wave IW is a circularly-polarized wave that rotates counterclockwise with respect to the forward direction, the reflective plate 114 can be used. In such a configuration, a circularly-polarized wave that rotates counterclockwise with respect to the forward direction as well is reflected as the reflected wave RW.

Therefore, according to such a modification, approximately the same advantage as that described in (1) is obtained.

(Fourth Modification)

In the embodiment, as shown in FIGS. 5 to 6B, the reflective plate 114 in which the distance D between the metal slits 114a and the metal plate 114b is set to be “λg/4” in electric length was arranged in a manner that the metal slits 114a of the plate was inclined by 45 degrees clockwise with respect to the polarization plane of the injected wave IW. However, when the electromagnetic wave IW transmitted from the communication control device 112 via the antenna 113 is the linearly-polarized wave, the reflective plate 214 having a reflective structure as shown in FIGS. 7G and 7H can be used instead of the reflective plate 114.

That is, in the reflective plate 214, the distance D (in FIG. 5) between the metal slits 114a and the metal plate 114b is set to be “λg/8” in electric length. Moreover, the reflective plate 214 is arranged in a manner that the metal slits 114a of the plate are inclined by 45 degrees clockwise with respect to the polarization plane of the injected wave IW. In such a reflection configuration, according to a principle previously described exemplifying FIGS. 2C and 2D, and FIGS. 3C and 3D, a circularly-polarized wave is reflected as the reflected wave RW of the injected wave.

Therefore, according to such a modification, approximately the same advantages as those described in (1) and (2) are obtained.

(Fifth Modification)

When the electromagnetic wave IW is the linearly-polarized wave, the reflective plate 214 can be arranged in a manner that the metal slits 114a of the plate are inclined by 45 degrees counterclockwise with respect to the polarization plane of the injected wave IW as shown in FIGS. 7I and 7J. Even in such a reflection structure, the circularly-polarized wave is reflected as the reflected wave RW of the injected wave.

Therefore, according to such a modification, approximately the same advantages as those described in (1) and (2) are obtained.

(Sixth Modification)

As shown in FIGS. 7K and 7L, even if the electromagnetic wave IW is a circularly-polarized wave that rotates clockwise with respect to the forward direction, the reflective plate 214 can be used. In such a configuration, a linearly-polarized wave is reflected as the reflected wave RW basically according to a principle previously described exemplifying FIGS. 2G and 2H, and FIGS. 3G and 3H.

Therefore, according to such a modification, approximately the same advantage as that described in (1) is obtained.

(Seventh Modification)

As shown in FIGS. 7M and 7N, even if the electromagnetic wave IW is a circularly-polarized wave that rotates counterclockwise with respect to the forward direction, the reflective plate 214 can be used. Even in such a configuration, a linearly-polarized wave is reflected as the reflected wave RW of the electromagnetic wave.

Therefore, according to such a modification, approximately the same advantage as that described in (1) is obtained.

(Second Embodiment)

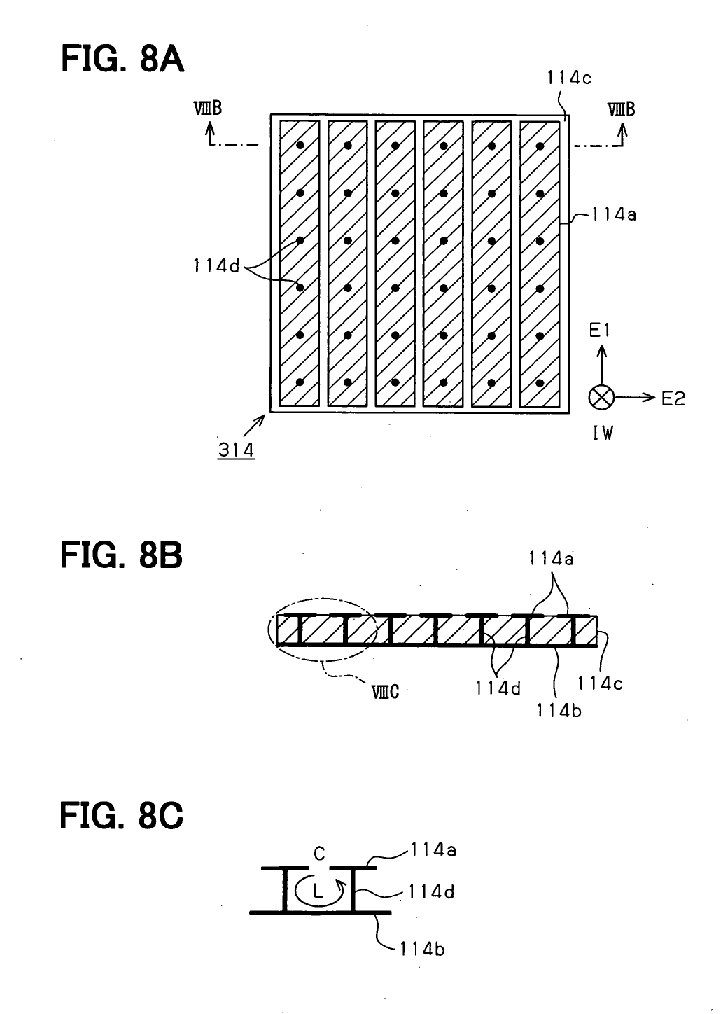

Next, a second embodiment of the radio communication system according to the invention is shown. Essentially, the radio communication system of the embodiment is in approximately the same configuration as the previous radio communication system of the first embodiment (FIG. 5). However, as shown in FIGS. 8A and 8B, the embodiment has a reflection structure employing a reflective plate 314 instead of the reflective plate 114, the plate 314 further having a plurality of through holes 114d, which form loops between the metal slits 114a and the metal plate 114b, in the dielectric 114c. Specifically, in each through hole 114d, a metal pillar is disposed so that the metal pillar contacts between the metal slit 114a and the metal plate 114b. Thus, the metal silt 114a, the metal pillar in the through hole 114d and the metal plate 114b provide a electric conductive loop. That is, as shown in FIG. 8C, in the reflective plate 314, when capacitance of the relevant reflective plate 314 determined depending on a distance between the metal slits 114a is assumed to be “C”, and inductance of the relevant reflective plate 314 determined depending on length of the loop is assumed to be “L”, a reflection phase of a vector component transmitted through the metal slits 114a is designed to be “zero degrees” through the “C” and “L”. Such a reflective plate 314 is arranged in a manner as shown in FIGS. 9A and 9B with respect to the electromagnetic wave (injected wave) IW transmitted from the antenna 113, so that interference between the injected wave IW and the reflected wave RW is relaxed. In FIGS. 9A and 9B, a relationship between the metal slits 114a and the metal plate 114b in the reflective plate 314 is particularly shown, and the dielectric 114c between the metal slits 114a and the metal plate 114b is omitted to be shown for convenience.

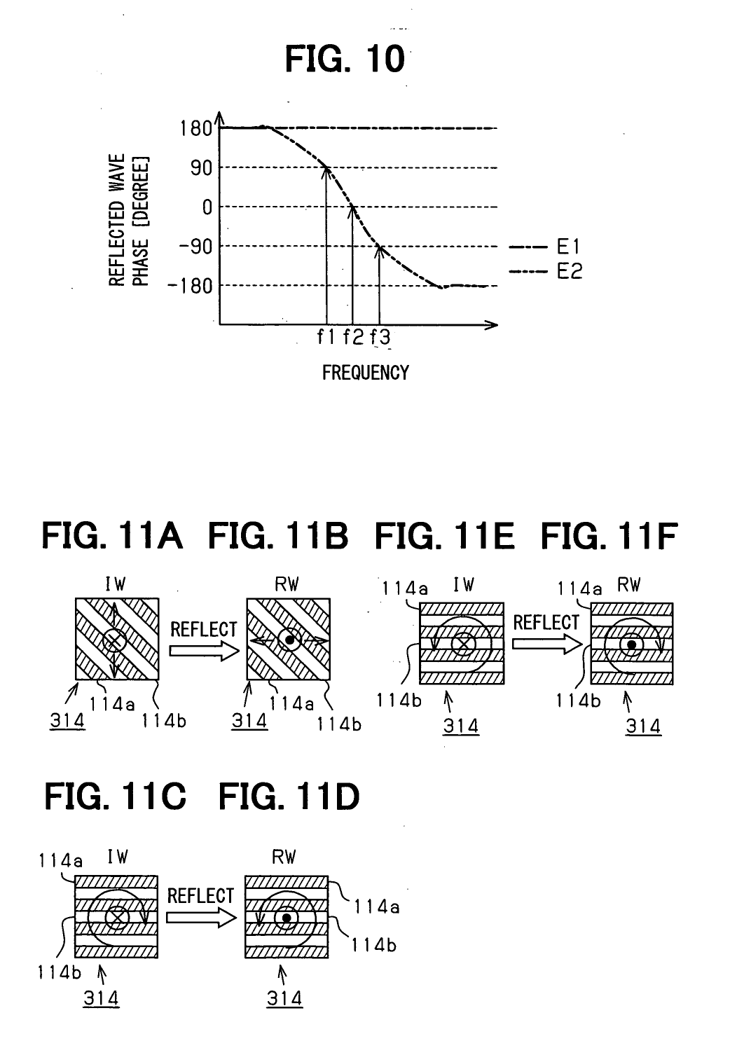

Here, an example of a setting procedure of the “C” and “L” with reference to FIG. 10 together is explained. FIG. 10 is a graph showing a relationship between the electromagnetic wave IW injected into the reflective plate 314 and the reflection phase of the reflected wave RW for each of electric field vectors E1 and E2 (shown in FIG. 8A) of the electromagnetic wave IW, wherein a horizontal axis in the figure indicates frequency of the electromagnetic wave IW, and a vertical axis indicates the reflection phase respectively.

As shown in FIG. 10, in such a reflective plate 314, in the injected electromagnetic wave IW, the electric field vector E2 transmitted through the metal slits 114a is varied in reflection phase due to effects of the “C” and “L”. Since the electric field vector E1 is reflected on surfaces of the metal slits 114a, the reflection phase of it is constant at “180 degrees”. On the other hand, when current is assumed to flow in a direction of the electric field vector E2 (shown in FIG. 8A) on a surface of the relevant reflective plate 314, equivalently the current can be considered to flow through a parallel resonance circuit of the “L” and “C”, and an impedance value “Z” of the circuit is expressed as follows;

Z=jωL/(1−ω²LC) (F1)

The impedance value “Z” is primarily derived for the reflection phase set in the reflective plate 314. Thus, in setting of such “C” and “L”, first the reflection phase to be set as a characteristic of the reflective plate 314, or the impedance value “Z” corresponding to “zero degrees” herein is calculated. Then, the calculated value “Z” and the frequency (ω) of the electromagnetic wave IW used in the relevant radio communication system are substituted into the equation (1) to obtain conditions of the “L” and “C”. Then, the distance between the metal slits 114a and the length of the through holes 114d (loop) and the like are determined by simulation and the like such that obtained conditions of the “L” and “C” are satisfied, thereby setting of the “L” and “C” are performed respectively. Thus, frequency f2 in the previous FIG. 10 corresponds to the frequency of the electromagnetic wave IW injected into the reflective plate 314, and the reflection phase of the vector component transmitted through the metal slits 114a is made to be “zero degrees” through the “L” and “C”.

As described hereinbefore, according to the radio communication system according to the second embodiment, advantages equal or according to the previous advantages (1) and (2) of the first embodiment can be essentially obtained.

The radio communication system according to the invention can be practiced not only by using the reflective plate or the reflection structure of the plate as shown in the second embodiment, but also by using reflective plates or reflection structures such as appropriate modifications of those in the second embodiment as exemplified below.

(First Modification)

In the embodiment, as shown in FIGS. 9A and 9B, the reflective plate 314 was arranged in a manner that the metal slits 114a of the plate were inclined by 45 degrees clockwise with respect to the polarization plane of the injected wave IW. However, when the electromagnetic wave IW transmitted from the communication control device 112 via the antenna 113 is linearly-polarized wave, the reflective plate 314 can be arranged in a mode as shown in FIGS. 11A and 11B with respect to the electromagnetic wave IW.

That is, the reflective plate 314 is arranged in a manner that the metal slits 114a of the plate are inclined by 45 degrees counterclockwise with respect to the polarization plane of the injected wave IW herein. Even in such a reflection structure, the polarization plane of the electromagnetic wave RW reflected by the reflective plate 314 is perpendicular to the polarization plane of the injected wave IW injected from the antenna 113 as the linearly-polarized wave.

Therefore, according to such a modification, approximately the same advantages as those described in (1) and (2) are obtained.

(Second Modification)

As shown in FIGS. 11C and 11D, even if the electromagnetic wave IW transmitted from the communication control device 112 via the antenna 113 is a circularly-polarized wave that rotates clockwise with respect to the forward direction, the reflective plate 314 can be used. In such a configuration, according to a principle previously described exemplifying FIGS. 2E and 2F, and FIGS. 3E and 3F, a circularly-polarized wave that rotates clockwise with respect to the forward direction as well is reflected as the reflected wave RW.

Therefore, according to such a modification, approximately the same advantage as that described in (1) is obtained.

(Third Modification)

As shown in FIGS. 11E and 11F, even if the electromagnetic wave IW is a circularly-polarized wave that rotates counterclockwise with respect to the forward direction, the reflective plate 314 can be used. Even in such a configuration, a circularly-polarized wave that rotates counterclockwise with respect to the forward direction as well is reflected as the reflected wave RW.

Therefore, according to such a modification, approximately the same advantage as that described in (1) is obtained.

(Fourth Modification)

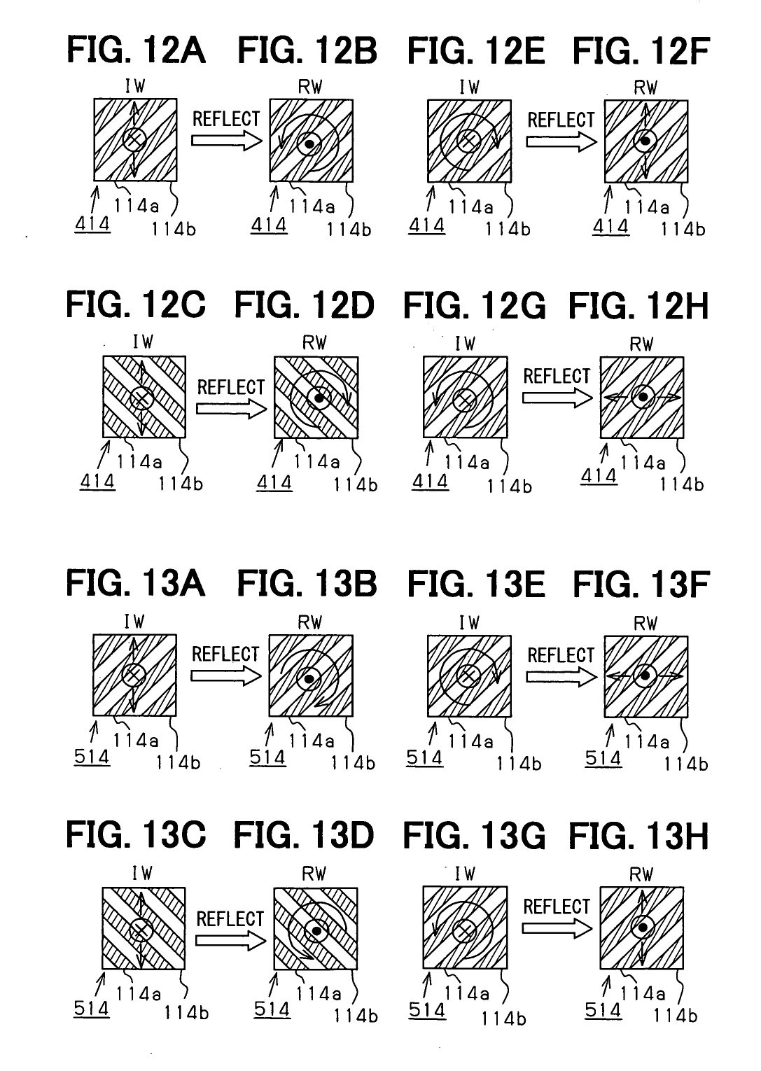

In the embodiment, the “C” and “L” were set in such a way that frequency f2 in the previous FIG. 10 corresponded to the frequency of the electromagnetic wave IW transmitted from the communication control device 112 via the antenna 113. Then, reflective plate 314 set in such a way was arranged in a manner that the metal slits 114a of the plate were inclined by 45 degrees clockwise with respect to the polarization plane of the injected wave IW as shown in FIGS. 9A and 9B. However, when the electromagnetic wave IW is a linearly-polarized wave, the reflective plate 414 having a reflective structure as shown in FIGS. 12A and 12B can be used instead of the reflective plate 314.

That is, in the reflective plate 414, the “C” and “L” are set in such a way that frequency f1 in the previous FIG. 10 corresponds to the frequency of the electromagnetic wave IW. Moreover, the reflective plate 414 is arranged in a manner that the metal slits 114a of the plate are inclined by 45 degrees clockwise with respect to the polarization plane of the injected wave IW. In such a reflection configuration, with respect to the electromagnetic wave IW transmitted from the antenna 113 as a linearly-polarized wave, a circularly-polarized wave is reflected as the reflected wave RW of the electromagnetic wave.

Therefore, according to such a modification, approximately the same advantages as those described in (1) and (2) are obtained.

(Fifth Modification)

When the electromagnetic wave IW is the linearly-polarized wave, the reflective plate 414 can be arranged in a manner that the metal slits 114a of the plate are inclined by 45 degrees counterclockwise with respect to the polarization plane of the injected wave IW as shown in FIGS. 12C and 12D. Even in such a reflection structure, the circularly-polarized wave is reflected as the reflected wave RW of the injected wave.

Therefore, according to such a modification, approximately the same advantages as those described in (1) and (2) are obtained.

(Sixth Modification)

As shown in FIGS. 12E and 12F, even if the electromagnetic wave IW transmitted from the communication control device 112 via the antenna 113 is a circularly-polarized wave that rotates clockwise with respect to the forward direction, the reflective plate 414 can be used. In such a configuration, a linearly-polarized wave is reflected as the reflected wave RW of the electromagnetic wave IW basically according to the principle previously described exemplifying FIGS. 2G and 2H, and FIGS. 3G and 3H.

Therefore, according to such a modification, approximately the same advantage as that described in (1) is obtained.

(Seventh Modification)

As shown in FIGS. 12G and 12H, even in the electromagnetic wave IW is a circularly-polarized wave that rotates counterclockwise with respect to the forward direction, the reflective plate 414 can be used. Even in such a configuration, a linearly-polarized wave is reflected as the reflected wave RW of the electromagnetic wave.

Therefore, according to such a modification, approximately the same advantage as that described in (1) is obtained.

(Eighth Modification)

In the embodiment, the “C” and “L” were set in such a way that frequency f2 in the previous FIG. 10 corresponded to the frequency of the electromagnetic wave IW transmitted from the communication control device 112 via the antenna 113. Then, the reflective plate 314 set in such a way was arranged in a manner that the metal slits 114a of the plate were inclined by 45 degrees clockwise with respect to the polarization plane of the injected wave IW as shown in FIGS. 9A and 9B. However, when the electromagnetic wave IW is a linearly-polarized wave, the reflective plate 514 having a reflective structure as shown in FIGS. 13A and 13B can be used instead of the reflective plate 314.

That is, in the reflective plate 514, the “C” and “L” are set such a way that frequency f3 in the previous FIG. 10 corresponds to the frequency of the electromagnetic wave IW. Moreover, the reflective plate 514 is arranged in a manner that the metal slits 114a of the plate are inclined by 45 degrees clockwise with respect to the polarization plane of the injected wave IW. In such a reflection configuration, a circularly-polarized wave is reflected as the reflected wave RW of the electromagnetic wave IW transmitted from the antenna 113 as a linearly-polarized wave, according to the principle previously described exemplifying FIGS. 2C and 2D, and FIG. 3C and 3D.

Therefore, according to such a modification, approximately the same advantages as those described in (1) and (2) are obtained.

(Ninth Modification)

When the electromagnetic wave IW is the linearly-polarized wave, the reflective plate 514 can be arranged in a manner that the metal slits 114a of the plate are inclined by 45 degrees counterclockwise with respect to the polarization plane of the injected wave IW as shown in FIGS. 13C and 13D. Even in such a reflection structure, the circularly-polarized wave is reflected as the reflected wave RW of the injected wave.

Therefore, according to such a modification, approximately the same advantages as those described in (1) and (2) are obtained.

(Tenth Modification)

As shown in FIGS. 13E and 13F, even if the electromagnetic wave IW transmitted from the communication control device 112 via the antenna 113 is a circularly-polarized wave that rotates clockwise with respect to the forward direction, the reflective plate 514 can be used. In such a configuration, according to the principle previously described exemplifying FIGS. 2G and 2H, and FIGS. 3G and 3H, a linearly-polarized wave is reflected as the reflected wave RW of the electromagnetic wave IW.

Therefore, according to such a modification, approximately the same advantage as that described in (1) is obtained.

(Eleventh Modification)

As shown in FIGS. 13G and 13H, even if the electromagnetic wave IW is a circularly-polarized wave that rotates counterclockwise with respect to the forward direction, the reflective plate 514 can be used. Even in such a configuration, a linearly-polarized wave is reflected as the reflected wave RW of the electromagnetic wave.

Therefore, according to such a modification, approximately the same advantage as that described in (1) is obtained.

(Third Embodiment)

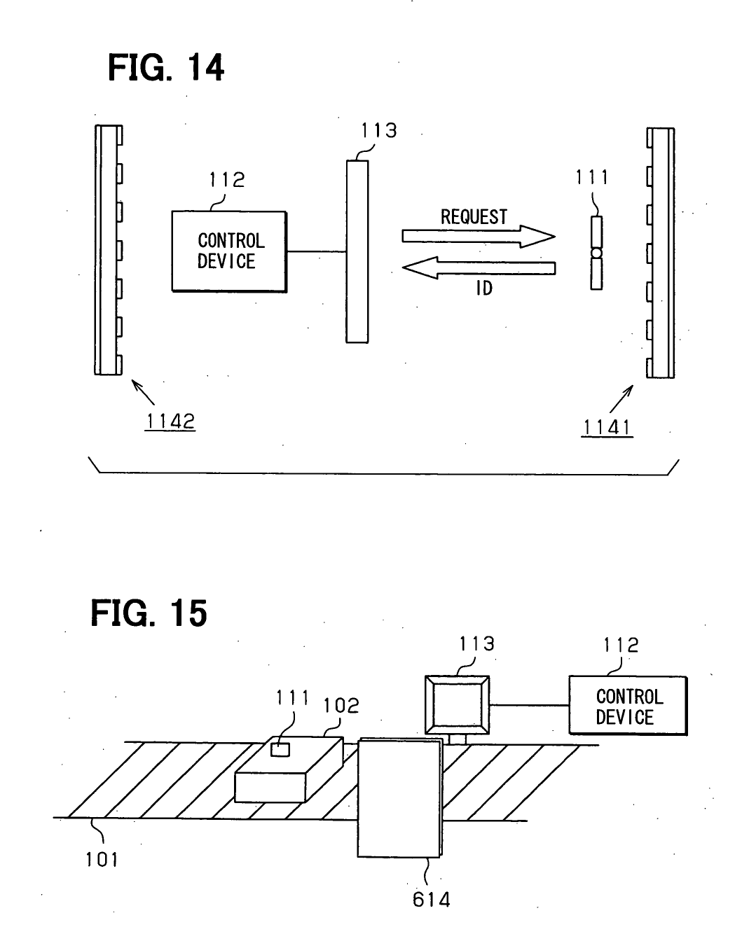

Next, a third embodiment of a radio communication system according to the invention is shown. Essentially, the radio communication system of the embodiment is in approximately the same configuration as the previous radio communication system (FIG. 5) of the first embodiment. However, in the radio communication system according to the embodiment, as seen in FIG. 14 that shows a general configuration of the system, when the previous reflective plate in the first embodiment is assumed to be a first reflective plate 1141, and a reflected wave reflected by the first reflective plate 1141 is assumed to be a first reflected wave RW1. The system further has; a second reflective plate 1142 that, when delivery and receipt of information is performed through radio communication between the communication control device 112 and the radio tag 111, reflects the first reflected wave RW1 at the back of the communication control device 112 and the radio tag 111 seen from the first reflective plate 1141.

The second reflective plate 1142 employs a reflective structure in which interference between an electromagnetic wave RW2 reflected by the plate itself and an electromagnetic wave RW1 reflected by the first reflective plate 1141 is relaxed. In such a configuration, in addition to interference between the electromagnetic wave IW transmitted from the antenna 113 and the first reflected wave RW1, interference between the first reflected wave RW1 and the second reflected wave RW2 is relaxed, therefore generation of the standing wave can be suppressed more preferably. Moreover, while generation of such a standing wave is suppressed, since delivery and receipt of information with respect to the radio tag 111 is performed in a region where the electromagnetic wave IW transmitted from the antenna 113, and the first and second reflected waves RW1 and RW2 are overlapped, further improvement in intensity of the electromagnetic wave imparted to the radio tag 111 can be expected.

As combinations of a type of the electromagnetic wave IW radiated from the antenna 113, a reflection structure of the first reflective plate 1141, and a reflection structure of the second reflective plate 1142 for realizing the radio communication system according to the embodiment, for example, the following combination patterns are given:

a first pattern, including: (A) the electromagnetic wave IW that is linearly-polarized wave; (B) a reflection structure of the first reflective plate 1141 that reflects an electromagnetic wave (first reflected wave) RW1 of the linearly-polarized wave having a different polarization plane from that in the electromagnetic wave IW; and (C) a reflection structure of the second reflective plate 1142 that reflects an electromagnetic wave (second reflected wave) RW2 of the circularly-polarized wave with respect to the first reflected wave RW1; and

a second pattern, including: (D) the electromagnetic wave IW that is circularly-polarized wave; (E) the reflection structure of the first reflective plate 1141 that reflects an electromagnetic wave (first reflected wave) RW1 of the circularly-polarized wave of which the rotation direction is the same as that in the electromagnetic wave IW in each of forward directions; and (F) the reflection structure of the second reflective plate 1142 that reflects an electromagnetic wave (second reflected wave) RW2 of the linearly-polarized wave with respect to the second reflected wave RW2.

Specifically, the reflection structures of the reflective plates 1141 and 1142 can be easily realized by appropriately using the previous reflection structures exemplified in FIGS. 6A and 6B, FIGS. 7A to 7N, FIGS. 9A and 9B, FIGS. 11A to 11F, FIGS. 12A to 12H, and FIGS. 13A to 13H.

As described hereinbefore, according to the radio communication system according to the third embodiment, in the previous advantages (1) and (2) of the first embodiment, at least the advantage (1) can be essentially obtained more significantly.

(Other Embodiments)

The respective embodiments can be practiced in a modified manner as follows.

The radio communication system according to the first and second embodiments may be applied to, for example, the following physical distribution management system. That is, as shown in FIG. 15, the physical distribution management system is a system, wherein each of loads (articles) 102 conveyed by a belt conveyer 101 is attached with a radio tag 111 in which identification information (ID) of a corresponding article 102 has been registered, or the identification information is to be registered, and physical distribution of the loads is managed based on the identification information. In the radio communication system applied to the physical distribution management system, the antenna 113 of the communication control device 112 and a reflective plate 614 are in a configuration where they are arranged oppositely in a manner of sandwiching the belt conveyer 101 and relaxing electromagnetic-wave interference in a region between them. According to such a physical distribution management system, delivery and receipt of information are appropriately performed between the radio tag 111 attached to the load (article) 102 conveyed by the belt conveyer 101 and the communication control device 112. In such a physical distribution management system, another reflective plate may be further arranged at the back of the antenna 113 seen from the reflective plate 614, as in the third embodiment.

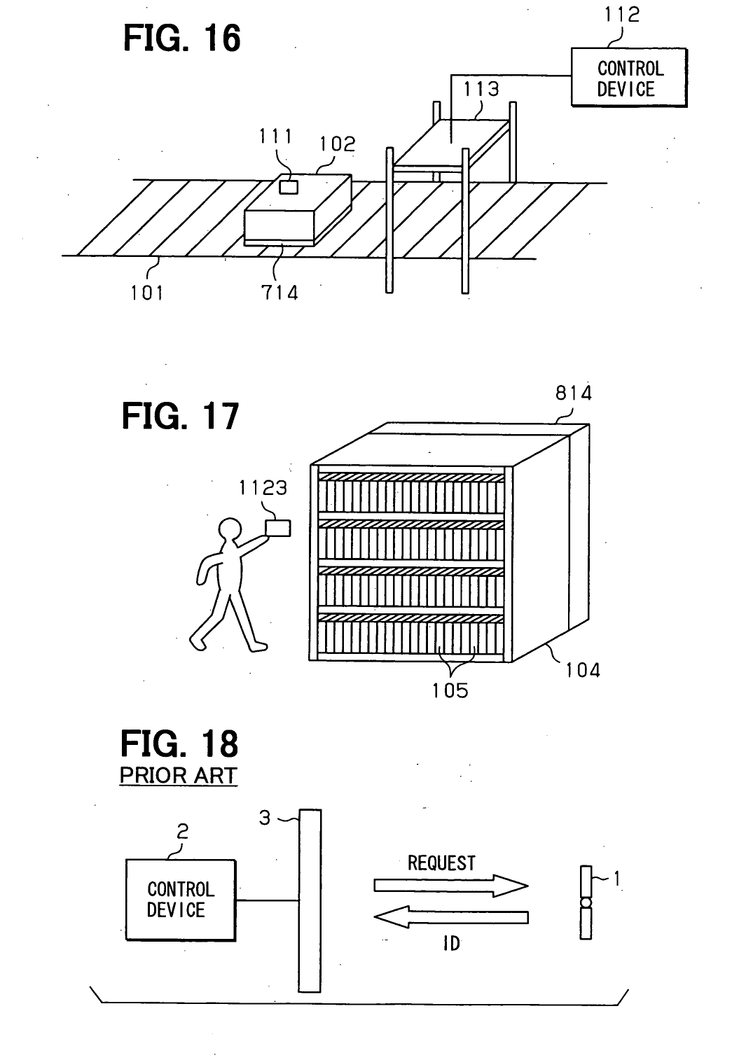

When the radio communication systems according to the first and second embodiments are applied to the physical distribution management system, a reflective plate 714 may be disposed below the load 102 conveyed by the belt conveyer 101, as shown in FIG. 16. However, in this case, the antenna 113 is arranged in a manner of radiating an electromagnetic wave to a conveying surface of the belt conveyer 101.

The radio communication system according to the first and second embodiments may be applied to, for example, the following book management system. That is, as shown in FIG. 17, the book management system is a system wherein each of books 105 stored in a bookshelf 104 is attached with a radio tag (omitted to be shown) in which identification information of a corresponding book 105 has been registered, or the identification information is to be registered, and the books are managed based on the identification information. In a radio communication system applied to the book management system, a communication control device 1123 incorporating a function of the antenna 113 is used. A reflective plate 814 is in a configuration where it is provided on a back of the bookshelf 104 to relax electromagnetic-wave interference in a region between the bookshelf and the communication control device 1123. According to such a book management system, an electromagnetic wave is transmitted from the front of the bookshelf 104 using the communication control device 1123, thereby delivery and receipt of information is appropriately performed between the radio tag (omitted to be shown) attached to the book 105 stored in the bookshelf 104 and the communication control device 1123. In such a book management system, another reflective plate may be further arranged at the back of the bookshelf 104 seen from the reflective plate 814, as in the third embodiment.

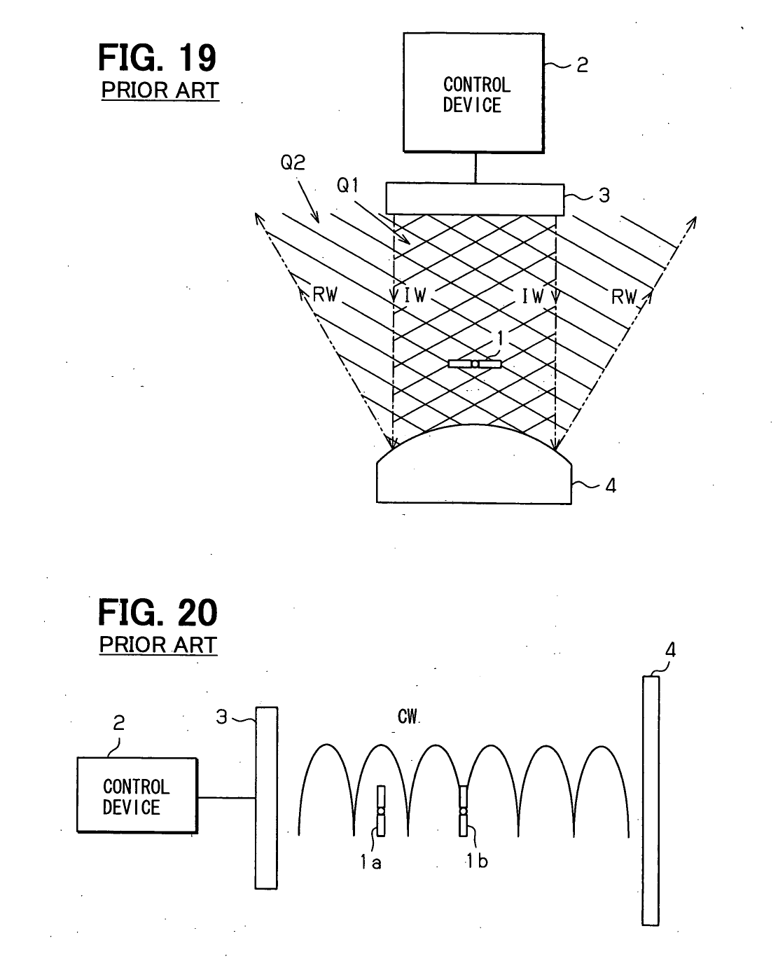

Regarding the reflective plates used in each of the embodiments, a shape of the plate may be appropriately modified as long as a reflection characteristic is maintained. For example, when a reflective surface of the plate is designed to be convex, expansion of the area of receiving the electromagnetic wave by the radio tag can be achieved as shown in the FIG. 19.

If a reflective plate has a reflection structure that makes a polarization plane of a reflected wave of an injected wave to be different from a polarization plane of the injected wave, the plate may be appropriately used as a reflective plate used in each of the embodiments. As such a reflective plate, for example, reflective plates are given, which make a polarization plane of a reflected wave of an injected wave to be different from a polarization plane of the injected wave through adjustment of a synthesized mode of vector components reflected by the metal slits 114a and the metal plate 114b respectively. Among them, a reflective plate that performs the adjustment of the synthesized mode by setting of the distance between the metal slits 114a and the metal plate 114b is the reflective plate used in the first embodiment. A reflective plate that performs the adjustment of the synthesized mode of the vector components by setting of the “C” and “L” is the reflective plate used in the second embodiment.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A radio communication system comprising:
a communication control device for processing information through a radio communication;
a radio tag as an information media for communicating with the communication control device through the radio communication;
an antenna for transmitting an electromagnetic wave as an incident wave from the communication control device to the radio tag; and
a first reflective plate for reflecting the electromagnetic wave transmitted from the antenna as a first reflected wave, wherein the radio tag is disposed between the antenna and the first reflective plate, wherein
the radio tag communicates with the communication control device in a region, in which the incident wave and the first reflected wave are overlapped, and
the first reflective plate reflects the incident wave in such a manner that the first reflected wave has a polarization different from a polarization of the incident wave.

2. The system according to claim 1, wherein
the incident wave is a linearly-polarized wave, and
the first reflected wave is a linearly-polarized wave.

3. The system according to claim 2, wherein
the polarization of the first reflected wave is perpendicular to the polarization of the incident wave.

4. The system according to claim 3, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component tilted from the polarization of the incident wave by 45 degrees, and reflects a second part of the incident wave having a second vector component perpendicular to the first vector component,
the metal plate reflects the first part of the incident wave, which is transmitted through the metal slit,
the first vector component of the first part of the incident wave has a wavelength in the dielectric substrate, which is defined as λg, and
a distance between the metal slit and the metal plate is λg/4 in electric length.

5. The system according to claim 3, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component tilted from the polarization of the incident wave by 45 degrees, and reflects a second part of the incident wave having a second vector component perpendicular to the first vector component,
the metal plate reflects the first part of the incident wave as a part of the first reflected wave, the first part which is transmitted through the metal slit,
the dielectric substrate includes a pair of through holes, in each of which a metal pillar is disposed so that the metal slit, a pair of the metal pillars and the metal plate provide a conductive loop,
the first reflective plate has a capacitance and an inductance,
the capacitance of the first reflective plate is defined in accordance with a clearance of the metal slit,
the inductance of the first reflective plate is defined in accordance with a length of the conductive loop, and
the capacitance and the inductance of the first reflective plate are determined in such a manner that a phase difference between the first vector component of the first part of the incident wave transmitted through the metal slit and the first vector component of the part of the first reflected wave reflected on the metal plate is 0 degree.

6. The system according to claim 1, wherein
the incident wave is a linearly-polarized wave, and
the first reflected wave is a circularly-polarized wave.

7. The system according to claim 6, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component tilted from the polarization of the incident wave by 45 degrees, and reflects a second part of the incident wave having a second vector component perpendicular to the first vector component,
the metal plate reflects the first part of the incident wave, which is transmitted through the metal slit,
the first vector component of the first part of the incident wave has a wavelength in the dielectric substrate, which is defined as λg, and
a distance between the metal slit and the metal plate is λg/8 in electric length.

8. The system according to claim 6, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component tilted from the polarization of the incident wave by 45 degrees, and reflects a second part of the incident wave having a second vector component perpendicular to the first vector component,
the metal plate reflects the first part of the incident wave as a part of the first reflected wave, the first part which is transmitted through the metal slit,
the dielectric substrate includes a pair of through holes, in each of which a metal pillar is disposed so that the metal slit, a pair of the metal pillars and the metal plate provide a conductive loop,
the first reflective plate has a capacitance and an inductance,
the capacitance of the first reflective plate is defined in accordance with a clearance of the metal slit,
the inductance of the first reflective plate is defined in accordance with a length of the conductive loop, and
the capacitance and the inductance of the first reflective plate are determined in such a manner that a phase difference between the first vector component of the first part of the incident wave transmitted through the metal slit and the first vector component of the part of the first reflected wave reflected on the metal plate is plus 90 degrees or minus 90 degrees.

9. The system according to claim 1, wherein
the incident wave is a circularly-polarized wave,
the first reflected wave is a circularly-polarized wave, and
the first reflected wave has a direction of polarization rotation with respect to a propagation direction of the first reflected wave, the direction being equal to a direction of polarization rotation of the incident wave with respect to a propagation direction of the incident wave.

10. The system according to claim 9, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component, and reflects a second part of the incident wave having a second vector component perpendicular to the first vector component,
the metal plate reflects the first part of the incident wave, which is transmitted through the metal slit,
the first vector component of the first part of the incident wave has a wavelength in the dielectric substrate, which is defined as λg, and
a distance between the metal slit and the metal plate is λg/4 in electric length.

11. The system according to claim 9, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component, and reflects a second part of the incident wave having a second vector component perpendicular to the first vector component,
the metal plate reflects the first part of the incident wave as a part of the first reflected wave, the first part which is transmitted through the metal slit,
the dielectric substrate includes a pair of through holes, in each of which a metal pillar is disposed so that the metal slit, a pair of the metal pillars and the metal plate provide a conductive loop,
the first reflective plate has a capacitance and an inductance,
the capacitance of the first reflective plate is defined in accordance with a clearance of the metal slit,
the inductance of the first reflective plate is defined in accordance with a length of the conductive loop, and
the capacitance and the inductance of the first reflective plate are determined in such a manner that a phase difference between the first vector component of the first part of the incident wave transmitted through the metal slit and the first vector component of the part of the first reflected wave reflected on the metal plate is 0 degree.

12. The system according to claim 1, wherein
the incident wave is a circularly-polarized wave, and
the first reflected wave is a linearly-polarized wave.

13. The system according to claim 12, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component, and reflects a second part of the incident wave having a second vector component perpendicular to the first vector component,
the metal plate reflects the first part of the incident wave, which is transmitted through the metal slit,
the first vector component of the first part of the incident wave has a wavelength in the dielectric substrate, which is defined as λg, and
a distance between the metal slit and the metal plate is λg/8 in electric length.

14. The system according to claim 12, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component, and reflects a second part of the incident wave having a second vector component perpendicular to the first vector component,
the metal plate reflects the first part of the incident wave as a part of the first reflected wave, the first part which is transmitted through the metal slit,
the dielectric substrate includes a pair of through holes, in each of which a metal pillar is disposed so that the metal slit, a pair of the metal pillars and the metal plate provide a conductive loop,
the first reflective plate has a capacitance and an inductance,
the capacitance of the first reflective plate is defined in accordance with a clearance of the metal slit,
the inductance of the first reflective plate is defined in accordance with a length of the conductive loop, and
the capacitance and the inductance of the first reflective plate are determined in such a manner that a phase difference between the first vector component of the first part of the incident wave transmitted through the metal slit and the first vector component of the part of the first reflected wave reflected on the metal plate is plus 90 degrees or minus 90 degrees.

15. The system according to claim 1, further comprising:
a second reflective plate disposed on an opposite side of the first reflective plate so that the antenna and the tag are disposed between the first reflective plate and the second reflective plate, wherein
the second reflective plate reflects the first reflected wave as a second reflected wave, and
the second reflected wave has a polarization, which is different from the polarization of the first reflected wave.

16. The system according to claim 15, wherein
the incident wave is a linearly-polarized wave,
the first reflected wave is a linearly-polarized wave,
the polarization of the first reflected wave is perpendicular to the polarization of the incident wave, and
the second reflected wave is a circularly-polarized wave.

17. The system according to claim 16, wherein
the first reflective plate includes a first metal slit, a first dielectric substrate and a first metal plate,
the first dielectric substrate is sandwiched between the first metal slit and the first metal plate,
the first metal slit faces the radio tag,
the first metal slit transmits a first part of the incident wave having a first vector component tilted from the polarization of the incident wave by 45 degrees, and reflects a second part of the incident wave having a second vector component perpendicular to the first vector component,
the first metal plate reflects the first part of the incident wave, which is transmitted through the first metal slit,
the first vector component of the first part of the incident wave has a wavelength in the first dielectric substrate, which is defined as λg₁,
a first distance between the first metal slit and the first metal plate is λg₁/4 in electric length,
the second reflective plate includes a second metal slit, a second dielectric substrate and a second metal plate,
the second dielectric substrate is sandwiched between the second metal slit and the second metal plate,
the second metal slit faces the antenna,
the second metal slit transmits a first part of the first reflected wave having a third vector component tilted from the polarization of the first reflected wave by 45 degrees, and reflects a second part of the first reflected wave having a fourth vector component perpendicular to the third vector component of the first reflected wave,
the second metal plate reflects the first part of the first reflected wave, which is transmitted through the second metal slit,
the third vector component of the first part of the first reflected wave has a wavelength in the second dielectric substrate, which is defined as λg₂, and
a second distance between the second metal slit and the second metal plate is λg₂/8 in electric length.

18. The system according to claim 16, wherein
the first reflective plate includes a first metal slit, a first dielectric substrate and a first metal plate,
the first dielectric substrate is sandwiched between the first metal slit and the first metal plate,
the first metal slit faces the radio tag,
the first metal slit transmits a first part of the incident wave having a first vector component tilted from the polarization of the incident wave by 45 degrees, and reflects a second part of the incident wave having a second vector component perpendicular to the first vector component,
the first metal plate reflects the first part of the incident wave as a part of the first reflected wave, the first part which is transmitted through the first metal slit,
the first dielectric substrate includes a pair of first through holes, in each of which a first metal pillar is disposed so that the first metal slit, a pair of the first metal pillars and the first metal plate provide a first conductive loop,
the first reflective plate has a first capacitance and a first inductance,
the first capacitance of the first reflective plate is defined in accordance with a first clearance of the first metal slit,
the first inductance of the first reflective plate is defined in accordance with a first length of the first conductive loop,
the first capacitance and the first inductance of the first reflective plate are determined in such a manner that a phase difference between the first vector component of the first part of the incident wave transmitted through the first metal slit and the first vector component of the part of the first reflected wave reflected on the first metal plate is 0 degree,
the second reflective plate includes a second metal slit, a second dielectric substrate and a second metal plate,
the second dielectric substrate is sandwiched between the second metal slit and the second metal plate,
the second metal slit faces the antenna,
the second metal slit transmits a first part of the first reflected wave having a third vector component tilted from the polarization of the first reflected wave by 45 degrees, and reflects a second part of the first reflected wave having a fourth vector component perpendicular to the third vector component of the first reflected wave,
the second metal plate reflects the first part of the first reflected wave as a part of the second reflected wave, the first part which is transmitted through the second metal slit,
the second dielectric substrate includes a pair of second through holes, in each of which a second metal pillar is disposed so that the second metal slit, a pair of the second metal pillars and the second metal plate provide a second conductive loop,
the second reflective plate has a second capacitance and a second inductance,
the second capacitance of the second reflective plate is defined in accordance with a second clearance of the second metal slit,
the second inductance of the second reflective plate is defined in accordance with a second length of the second conductive loop, and
the second capacitance and the second inductance of the second reflective plate are determined in such a manner that a phase difference between the third vector component of the first part of the first reflected wave transmitted through the second metal slit and the third vector component of the part of the second reflected wave reflected on the second metal plate is plus 90 degrees or minus 90 degrees.

19. The system according to claim 15, wherein
the incident wave is a circularly-polarized wave,
the first reflected wave is a circularly-polarized wave,
the first reflected wave has a direction of polarization rotation with respect to a propagation direction of the first reflected wave, the direction being equal to a direction of polarization rotation of the incident wave with respect to a propagation direction of the incident wave, and
the second reflected wave is a linearly-polarized wave.

20. The system according to claim 19, wherein
the first reflective plate includes a first metal slit, a first dielectric substrate and a first metal plate,
the first dielectric substrate is sandwiched between the first metal slit and the first metal plate,
the first metal slit faces the radio tag,
the first metal slit transmits a first part of the incident wave having a first vector component, and reflects a second part of the incident wave having a second vector component perpendicular to the first vector component,
the first metal plate reflects the first part of the incident wave, which is transmitted through the first metal slit,
the first vector component of the first part of the incident wave has a wavelength in the first dielectric substrate, which is defined as λg₁,
a first distance between the first metal slit and the first metal plate is λg₁/4 in electric length,
the second reflective plate includes a second metal slit, a second dielectric substrate and a second metal plate,
the second dielectric substrate is sandwiched between the second metal slit and the second metal plate,
the second metal slit faces the antenna,
the second metal slit transmits a first part of the first reflected wave having a third vector component, and reflects a second part of the first reflected wave having a fourth vector component perpendicular to the third vector component of the first reflected wave,
the second metal plate reflects the first part of the first reflected wave, which is transmitted through the second metal slit,
the third vector component of the first part of the first reflected wave has a wavelength in the second dielectric substrate, which is defined as λg₂, and
a second distance between the second metal slit and the second metal plate is λg₂/8 in electric length.

21. The system according to claim 19, wherein
the first reflective plate includes a first metal slit, a first dielectric substrate and a first metal plate,
the first dielectric substrate is sandwiched between the first metal slit and the first metal plate,
the first metal slit faces the radio tag,
the first metal slit transmits a first part of the incident wave having a first vector component, and reflects a second part of the incident wave having a second vector component perpendicular to the first vector component,
the first metal plate reflects the first part of the incident wave as a part of the first reflected wave, the first part which is transmitted through the first metal slit,
the first dielectric substrate includes a pair of first through holes, in each of which a first metal pillar is disposed so that the first metal slit, a pair of the first metal pillars and the first metal plate provide a first conductive loop,
the first reflective plate has a first capacitance and a first inductance,
the first capacitance of the first reflective plate is defined in accordance with a first clearance of the first metal slit,
the first inductance of the first reflective plate is defined in accordance with a first length of the first conductive loop,
the first capacitance and the first inductance of the first reflective plate are determined in such a manner that a phase difference between the first vector component of the first part of the incident wave transmitted through the first metal slit and the first vector component of the part of the first reflected wave reflected on the first metal plate is 0 degree,
the second reflective plate includes a second metal slit, a second dielectric substrate and a second metal plate,
the second dielectric substrate is sandwiched between the second metal slit and the second metal plate,
the second metal slit faces the antenna,
the second metal slit transmits a first part of the first reflected wave having a third vector component, and reflects a second part of the first reflected wave having a fourth vector component perpendicular to the third vector component of the first reflected wave,
the second metal plate reflects the first part of the first reflected wave as a part of the second reflected wave, the first part which is transmitted through the second metal slit,
the second dielectric substrate includes a pair of second through holes, in each of which a second metal pillar is disposed so that the second metal slit, a pair of the second metal pillars and the second metal plate provide a second conductive loop,
the second reflective plate has a second capacitance and a second inductance,
the second capacitance of the second reflective plate is defined in accordance with a second clearance of the second metal slit,
the second inductance of the second reflective plate is defined in accordance with a second length of the second conductive loop, and
the second capacitance and the second inductance of the second reflective plate are determined in such a manner that a phase difference between the third vector component of the first part of the first reflected wave transmitted through the second metal slit and the third vector component of the part of the second reflected wave reflected on the second metal plate is plus 90 degrees or minus 90 degrees.

22. The system according to claim 1, wherein
the first reflective plate includes a metal slit, a dielectric substrate and a metal plate,
the dielectric substrate is sandwiched between the metal slit and the metal plate,
the metal slit faces the radio tag,
the metal slit transmits a first part of the incident wave having a first vector component, and reflects a second part of the incident wave having a second vector component perpendicular to the first vector component,
the metal plate reflects the first part of the incident wave as a part of the first reflected wave, the first part which is transmitted through the metal slit, and
the first part of the incident wave reflected on the metal plate and the second part of the incident wave reflected on the metal slit provide the first reflected wave in such a manner that the first part of the incident wave and the second part of the incident wave are synthesized in order to have the polarization of the first reflected wave different from the polarization of the incident wave.

23. The system according to claim 22, wherein
a distance between the metal slit and the metal plate is determined to have the polarization of the first reflected wave different from the polarization of the incident wave.

24. The system according to claim 22, wherein
the dielectric substrate includes a pair of through holes, in each of which a metal pillar is disposed so that the metal slit, a pair of the metal pillars and the metal plate provide a conductive loop,
the first reflective plate has a capacitance and an inductance,
the capacitance of the first reflective plate is defined in accordance with a clearance of the metal slit,
the inductance of the first reflective plate is defined in accordance with a length of the conductive loop, and
the capacitance and the inductance of the first reflective plate are determined in order to have the polarization of the first reflected wave different from the polarization of the incident wave.

25. The system according to claim 1, wherein
the radio tag is mounted on a package, which is transported by a conveyor, and
the antenna is disposed on one side of the conveyor, and the first reflective plate is disposed on the other side of the conveyor.

26. The system according to claim 1, wherein
the radio tag is mounted on a package, which is transported by a conveyor,
the package with the radio tag is disposed on the reflective plate so that the package together with the radio tag and the reflective plate are transported by the conveyor, and
the antenna is disposed over the conveyor so that the incident wave is emitted from the antenna toward the conveyor.

27. The system according to claim 1, wherein
the radio tag is mounted on a book, which is stored in a bookshelf,
the reflective plate is disposed on a back of the bookshelf, and
the communication control device with the antenna is transported by a person, who checks the book in the bookshelf.
